(19) United States
(12) Patent Application Publication
(10) Pub. No.: US 2026/0264251 A1
(43) Pub. Date: Sep. 10, 2026

(54) VISION SYSTEM AND VISION DETECTION METHOD

(71) Applicant: FANUC CORPORATION, Minamitsuru-gun, Yamanashi (JP)

(72) Inventor: Weijia LI, Minamitsuru-gun, Yamanashi (JP)

(21) Appl. No.: 18/876,272

(22) PCT Filed: Jul. 5, 2022
(86) PCT No.: PCT/JP2022/026701

§ 371 Date: Dec. 18, 2024

(51) Int. Cl. B25J 9/16; B25J 13/08

(52) U.S. Cl. CPC B25J 9/1697; B25J 9/1653; B25J 9/1664; B25J 13/082

(57) ABSTRACT

A vision system is equipped with an acquisition unit for acquiring a first image which depicts a region where workpieces are present, a detection unit for outputting detection results about the workpieces, and a robot for executing an operation for changing the position of one or more of the workpieces. The robot executes a first operation for changing the position of the workpieces. The acquisition unit acquires a second image which depicts the region where the workpieces are present after the first operation. The detection unit subjects the first and second images to detection, and outputs one or more elements from among the positions of the workpieces, the posture thereof and the outer shape information thereof as the detection results based on at least the amount of change between the first image data, which includes detection results, and the second image data, which includes detection results.

### TECHNICAL FIELD

The present invention relates to a vision system and a vision detection method.

### BACKGROUND ART

There are applications where a vision detection is executed on images captured by 2D/3D cameras to determine the detection position, posture, and external shape of a workpiece, based on the detection results, enabling a robot to pick up the workpiece.

For instance, Patent Document 1 proposes a technique of moving a robot hand to induce a collapse of stacked workpieces, capturing images again after the collapse, and identifying newly grippable workpieces.

Patent Document 2 suggests a technique of causing a robot to contact a workpiece, measuring the force applied to the robot as well as each joint position of the robot during the contact, calculating the tip position of the end effector through forward kinematics based on the joint positions, updating the surface shape of the workpiece, and finding a new gripping position to grip the workpiece.

### CITATION LIST

### Patent Document

Patent Document 1: Japanese Unexamined Patent Application, Publication No. 2019-198949
Patent Document 2: Japanese Unexamined Patent Application, Publication No. 2017-136677

### DISCLOSURE OF THE INVENTION

### Problems to be Solved by the Invention

Patent Document 1 involves a possibility that the operation to induce the collapse of workpieces may result in an adverse state where two workpieces are stuck together. In this case, the two workpieces stuck together may be erroneously detected as a single large workpiece, potentially causing inability to accurately detect the position, posture, and external size of the workpieces.

Meanwhile, in Patent Document 2, the contact operation is suspended when the measured force reaches a threshold. However, force information is not used for updating the map data needed for recalculation (i.e., vision detection) of the surface shape of the workpiece. Patent Document 2 uses the measurement values of each joint position of the robot to calculate the tip position of the end effector in order to update the map data that is three-dimensional point cloud data. However, the accuracy of the calculated tip position of the end effector may be adversely affected by backlash in the reduction gears within the robot body, or manufacturing errors and deflection of the robot arm and the end effector/hand, resulting in poor accuracy. Consequently, in Patent Document 2, there is a problem in that it is not possible to create highly accurate map data, create highly accurate workpiece surface shapes, and obtain highly accurate detection results.

When executing vision detection on captured images, there are cases where tape or labels attached to the cardboard box serving as a workpiece may cause erroneous detection of the position and external size of the workpiece, outputting incorrect vision detection results.

For example, densely stacked cardboard boxes may include gaps that are not detected by vision, causing the portion including the gaps to be erroneously detected as a detection position. Similarly, small grooves, steps, or holes may not be detected by vision, causing the portion including such features to be erroneously detected as a detection position. In these cases, when a robot hand with suction pads attempts to pick up a workpiece such as a cardboard box at the detected position, air may leak, causing the pick-up operation to fail.

Therefore, it is desired to accurately determine the pick-up position for a robot to pick up a workpiece, based on the detection results of the vision detection of the images.

### Means for Solving the Problems

The vision system according to one aspect of the present disclosure includes: an acquisition unit configured to acquire a first type of image in which a presence and surrounding region of a plurality of workpieces is captured; a detection unit configured to output a result of detecting the plurality of workpieces; and a robot configured to execute an operation to change a position of at least one of the plurality of workpieces, in which the robot executes a first operation to change positions of the plurality of workpieces, the acquisition unit acquires a second type of image in which the presence and surrounding region of the plurality of workpieces is captured after executing the first operation, and the detection unit executes detection on the first type of image and the second type of image, and outputs at least one information of a position, posture, or external shape information of the plurality of workpieces as the detection result, based on at least the information of an amount of change calculated between first type of image data which containing the detection result and second type of image data which containing the detection result.

The vision detection method according to one aspect of the present disclosure includes: an acquiring step of acquiring a first type of image in which a presence and surrounding region of a plurality of workpieces is captured; a detecting step of outputting a result of detecting the plurality of workpieces; and an executing step of causing a robot to execute an operation to change a position of at least one of the plurality of workpieces, in which, in the executing step, the robot executes a first operation to change positions of the plurality of workpieces, in the acquiring step, a second type of image is acquired, in which a presence and surrounding region of the plurality of workpieces after executing the first operation is captured, and in the detecting step, detection on the first type of image and the second type of image is executed, and at least one information of a position, posture, or external shape information of the plurality of workpieces is output as the detection result, based on at least the information of an amount of change calculated between the first type of image data which containing the detection result and the second type of image data which containing the detection result.

### Effects of the Invention

According to one aspect of the present disclosure, the pick-up position for a robot to pick up a workpiece can be accurately determined based on the detection results of the vision detection of the images.

### BRIEF DESCRIPTION OF THE DRAWINGS

FIG. 1 is a diagram illustrating an example of the configuration of the vision system according to the first embodiment;

FIG. 2 is a functional block diagram illustrating an example of the functional configuration of the vision detection device;

FIG. 3 is a diagram illustrating an example of an image of the presence and surrounding region of a plurality of cardboard boxes before changing the positions of the cardboard boxes;

FIG. 4 is a diagram illustrating an example of an image captured after changing the positions of the cardboard boxes in FIG. 3;

FIG. 5 is a diagram illustrating another example of an image captured after changing the positions of the cardboard boxes in FIG. 4;

FIG. 6 is a diagram illustrating an example of the final detection result;

FIG. 7 is a flowchart illustrating the detection processing of the vision system;

FIG. 8 is a diagram illustrating an example of the configuration of the vision system according to the second embodiment;

FIG. 9 is a functional block diagram illustrating an example of the functional configuration of the vision detection device;

FIG. 10 is a flowchart illustrating the detection processing of the vision system;

FIG. 11 is a diagram illustrating an example of the configuration of the vision system according to the third embodiment;

FIG. 12 is a functional block diagram illustrating an example of the functional configuration of the vision detection device;

FIG. 13 is a diagram illustrating an example of the waveform of the contact force generated by the contact with the surface of a cardboard box, as measured by a tactile/haptic sensor;

FIG. 14 is a flowchart illustrating the detection processing of the vision system; and

FIG. 15 is a diagram illustrating an example of the waveform of the force generated by the contact with the top surface of a workpiece, as measured by the tactile/haptic sensor.

### PREFERRED MODE FOR CARRYING OUT THE INVENTION

The first through third embodiments will be described in detail with reference to the drawings.

Here, each embodiment commonly involves the configuration of executing vision detection of a first type of image capturing the presence and surrounding region of workpieces, causing a robot to execute a first operation on the workpieces to obtain at least one of the position, posture, or external shape information on the workpieces, and outputting at least one of the position, posture, or external shape information on the workpieces as the detection result.

However, in the first embodiment, in a state where the plurality of workpieces are densely stacked, the robot executes the first operation to change the positions of the plurality of workpieces. After executing the first operation, the second type of image capturing the presence and surrounding region of the plurality of workpieces is acquired. Vision detection is executed on the first type of image and the second type of image, and the results of detecting the plurality of workpieces are output based on the amount of change between the first type of image data containing the detection results and the second type of image data containing the detection results. In contrast, in the second embodiment, in a case where there are regions where the vision detection fails to acquire three-dimensional positions (for example, when halation occurs or when the workpiece is transparent), the robot executes the first operation to touch the workpiece in the failed regions, and the contact information indicating the three-dimensional positions of the failed regions is acquired. The detection results are corrected by supplementing the three-dimensional positions of the failed regions, based on the acquired contact information. This is a point of difference from the first embodiment. In the third embodiment, in a case where the surface of a single workpiece is not uniform and the features divide the surface, leading to erroneous detection that a plurality of workpieces exist (e.g., textures or materials are different in different regions on the surface), the robot executes the first operation to touch the workpiece surface, identifies changes in texture on the workpiece, distinguishes the regions, and corrects the detection result. This is a point of difference from the first and second embodiments.

Hereinafter, the first embodiment will be described in detail, followed by the description focusing on the differences between the first embodiment and the second and third embodiments.

### First Embodiment

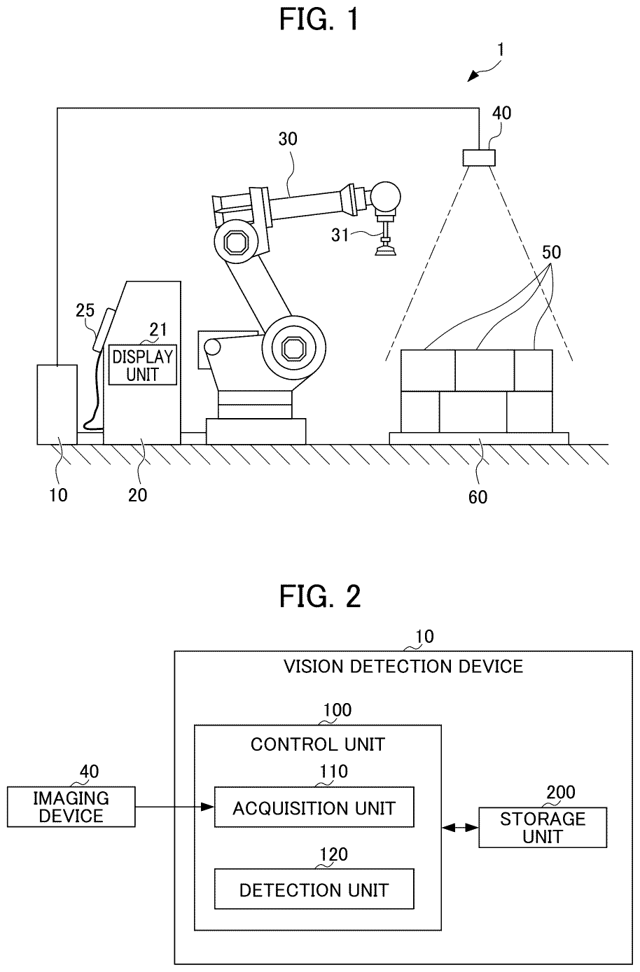

FIG. 1 is a diagram illustrating an example of the configuration of the vision system according to the first embodiment. Here, a plurality of densely stacked cardboard boxes are illustrated as an example of the workpieces. The present invention can be applied to workpieces other than cardboard boxes, such as jigs, and also to workpieces with shapes such as triangles or hexagons.

As illustrated in FIG. 1, the vision system 1 includes a vision detection device 10, a robot control device 20, a robot 30, an imaging device 40, a plurality of cardboard boxes 50, and a pallet 60.

The vision detection device 10, the robot control device 20, the robot 30, and the imaging device 40 may be directly connected to each other via connection interfaces (not illustrated). The vision detection device 10, the robot control device 20, the robot 30, and the imaging device 40 may also be connected to each other via a network (not illustrated), such as a LAN (Local Area Network) or the Internet. In this case, the vision detection device 10, the robot control device 20, the robot 30, and the imaging device 40 include communication units (not illustrated) for mutual communication via such connections. For ease of description, FIG. 1 illustrates the vision detection device 10 and the robot control device 20 as separate units, in which case, the vision detection device 10 may be configured with a computer, for example. However, such a configuration is not limiting, and the vision detection device 10 may be mounted inside the robot control device 20 and integrated into the robot control device 20, as described later.

The robot control device 20 is a device known to those skilled in the art for controlling the operations of the robot 30. In FIG. 1, a teaching console 25 for teaching the operations to the robot 30 is connected to the robot control device 20. The robot control device 20 includes a display unit 21, such as an LCD display.

Based on the detection results output from the vision detection device 10 described later, the robot control device 20 operates the robot 30 to change the position of at least one of the densely stacked cardboard boxes 50. The robot control device 20 receives the detection results of the cardboard boxes 50 detected by the vision detection device 10 described later, using the image of the presence and surrounding region of the plurality of cardboard boxes 50 captured by the imaging device 40 before changing the positions, and the image of the presence and surrounding region of the plurality of cardboard boxes 50 captured after changing the positions. The robot control device 20 displays the received detection results together with the images captured by the imaging device 40 on the display unit 21 of the robot control device 20. Based on the received detection results or the selection instructions by the user via the teaching console 25, the robot control device 20 selects a cardboard box 50 to pick up. The robot control device 20 generates control signals for controlling the robot 30 in order to move the hand 31 of the robot 30 to the position to pick up the selected cardboard box 50. The robot control device 20 outputs the generated control signals to the robot 30.

The display unit 21 may be arranged on the teaching console 25.

The robot control device 20 may include the vision detection device 10, as described later.

The robot 30 is a robot that operates under the control of the robot control device 20. The robot 30 includes a base portion that rotates around a vertical axis, an arm that moves and rotates, and a hand 31 that is attached to the arm in order to hold the cardboard box 50. In FIG. 1, a picking hand of an air suction type is attached to the hand 31 of the robot 30, but a picking hand of a gripping type may also be attached.

The robot 30 drives the arm and the hand 31 in accordance with the control signals output by the robot control device 20, moves the hand 31 to the position to pick up the selected cardboard box 50, and holds and picks up the selected cardboard box 50 from the pallet 60.

Illustration of the destination to transfer the picked up cardboard box 50 is omitted. Detailed configuration of the robot 30 is well-known to those skilled in the art and is therefore omitted.

The vision detection device 10 and the robot control device 20 are pre-calibrated to associate the machine coordinate system for controlling the robot 30 and the camera coordinate system of detection results indicating the position, posture, and external shape information on the cardboard box 50.

The imaging device 40, such as a digital camera, captures a two-dimensional image of the presence and surrounding region of the plurality of cardboard boxes 50 densely stacked on the pallet 60, as projected onto a plane perpendicular to the optical axis of the imaging device 40. The images captured by the imaging device 40 may be visible light images, such as RGB color images, grayscale images, or depth images. The imaging device 40 may include an infrared sensor configured to capture thermal images, or an ultraviolet sensor configured to capture ultraviolet images for inspecting defects or marks on object surfaces. The imaging device 40 may include an X-ray camera sensor configured to capture X-ray images, or an ultrasonic sensor configured to capture ultrasonic images. The imaging device 40 may also be a three-dimensional measurement device such as a stereo camera.

The cardboard boxes 50 are densely stacked on the pallet 60. As described above, the workpieces are not limited to the cardboard boxes 50 and may be any object that can be held by the hand 31 attached to the arm of the robot 30, with no particular limitation on shape.

### Vision Detection Device 10

FIG. 2 is a functional block diagram illustrating an example of the functional configuration of the vision detection device 10.

The vision detection device 10 is a computer known to those skilled in the art, including a control unit 100 and a storage unit 200, as illustrated in FIG. 2. The control unit 100 includes an acquisition unit 110 and a detection unit 120.

### Storage Unit 200

The storage unit 200 can be a SSD (Solid State Drive) or a HDD (Hard Disk Drive), among other storage devices. The storage unit 200 stores images captured by the imaging device 40 and acquired by the acquisition unit 110, together with the operating system and the application programs executed by the control unit 100.

### Control Unit 100

The control unit 100 includes a CPU (Central Processing Unit), ROM, RAM (Random Access Memory), CMOS (Complementary Metal-Oxide-Semiconductor) memory, etc., which are mutually communicable via a bus, as is well known to those skilled in the art.

The CPU is the processor that controls the vision detection device 10 as a whole. The CPU reads the system programs and application programs stored in the ROM via the bus and controls the entirety of the vision detection device 10 in accordance with the programs. As a result, the control unit 100 is configured to implement the functions of the acquisition unit 110 and the detection unit 120, as illustrated in FIG. 2. The RAM stores various types of data, such as temporary calculation data and display data. The CMOS memory, backed up by a battery (not illustrated), functions as non-volatile memory that retains the stored state even when the power of the vision detection device 10 is turned off.

### Acquisition Unit 110

The acquisition unit 110 acquires images from the imaging device 40, such as images of the presence and surrounding region of the plurality of cardboard boxes 50. The acquisition unit 110 stores the acquired images in the storage unit 200.

The acquisition unit 110 acquires images from the imaging device 40 and may also acquire three-dimensional point cloud data or distance image data.

### Detection Unit 120

For example, the detection unit 120 detects the plurality of cardboard boxes 50 in both the image of the presence and surrounding region of the plurality of cardboard boxes 50 captured by the imaging device 40 before the robot control device 20 operates the robot 30 to change the positions of the cardboard boxes 50 (the first type of image) and the image of the presence and surrounding region of the plurality of cardboard boxes 50 captured by the imaging device 40 after changing the positions (the second type of image), and outputs the detection results to the robot control device 20, including the positions, posture, and external shape information on the plurality of cardboard boxes 50, based on at least the amount of change between the first type of image data containing the detection results and the second type of image data containing the detection results.

Specifically, for example, the detection unit 120 reads the image of the presence and surrounding region of the plurality of cardboard boxes 50 captured by the imaging device 40 before the robot control device 20 operates the robot 30 to change the positions of the cardboard boxes 50 (the first type of image) from the storage unit 200, and executes vision detection on the read image.

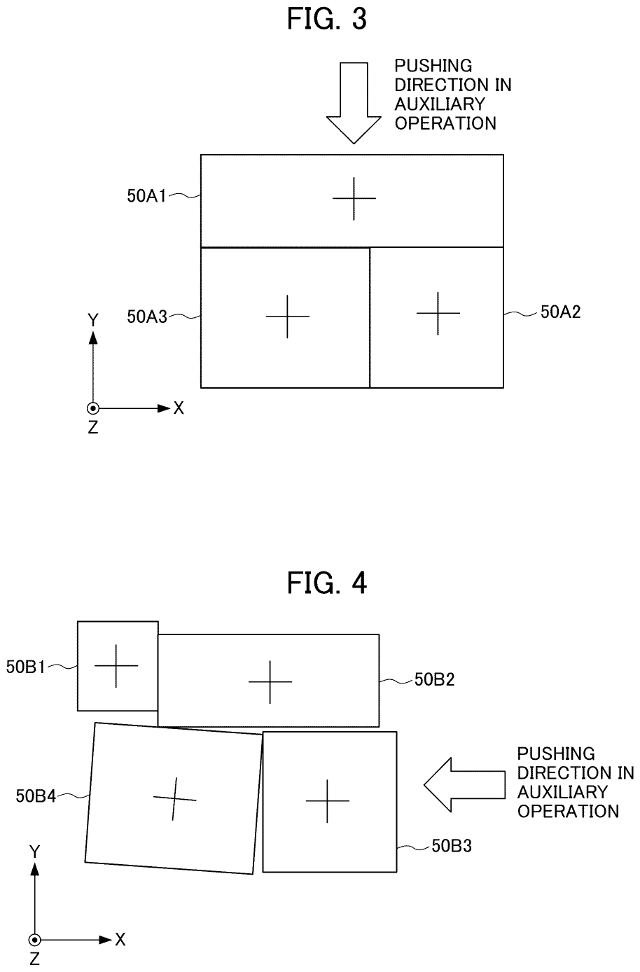

FIG. 3 is a diagram illustrating an example of the image of the presence and surrounding region of the plurality of cardboard boxes 50 before changing the positions of the cardboard boxes 50. The image in FIG. 3 is the plurality of cardboard boxes 50 captured from above by the imaging device 40 in the Z-axis direction, for example.

Through vision detection on the image in FIG. 3, the detection unit 120 detects the three densely stacked cardboard boxes 50A1, 50A2, and 50A3 (represented as thick-lined rectangles in the top view of the cardboard boxes 50) and acquires the positions (positions marked with a plus sign) X_{A1}, X_{A2}, X_{A3}, the posture P_{A1}, P_{A2}, P_{A3}, and the external shape information (such as width W_{A1}, W_{A2}, W_{A3} and depth D_{A1}, D_{A2}, D_{A3} of the thick-lined rectangles) of the detected cardboard boxes 50A1, 50A2, and 50A3.

Next, the detection unit 120 reads the image (second type of image) captured by the imaging device 40 from the storage unit 200 after the positions of the plurality of cardboard boxes 50 are changed by the robot control device 20 using the hand 31 attached to the robot 30 to execute an operation (first operation, auxiliary operation) to apply a force in the direction indicated by the arrow in FIG. 3 (Y-axis direction) to the three cardboard boxes 50A1, 50A2, and 50A3, and executes vision detection on the read image.

FIG. 4 is a diagram illustrating an example of the image captured after changing the positions of the cardboard boxes 50 illustrated in FIG. 3.

As illustrated in FIG. 4, through vision detection on the image, the detection unit 120 detects the four cardboard boxes 50B1, 50B2, 50B3, and 50B4 (represented as thick-lined rectangles) and acquires the positions (positions marked with a plus sign) X_{B1}, X_{B2}, X_{B3}, X_{B4}, the posture P_{B1}, P_{B2}, P_{B3}, P_{B4}, and the external shape information (width W_{B1}, W_{B2}, W_{B3}, W_{B4} and depth D_{B1}, D_{B2}, D_{B3}, D_{B4}) of the detected cardboard boxes 50B1, 50B2, 50B3, and 50B4. In other words, although the detection unit 120 erroneously detected the cardboard box 50A1 in FIG. 3 as a single cardboard box, the auxiliary operation by the robot 30 has allowed the detection unit 120 to successfully detect the gap between the two cardboard boxes 50B1 and 50B2, thereby correctly detecting the cardboard boxes 50B1 and 50B2.

Furthermore, the detection unit 120 reads the image (third type of image) captured by the imaging device 40 from the storage unit 200 after the positions of the plurality of cardboard boxes 50 are changed by the robot control device 20 using the hand 31 attached to the robot 30 to execute an auxiliary operation (second operation) to apply a force in the direction indicated by the arrow in FIG. 4 (X-axis direction) to the four cardboard boxes 50B1, 50B2, 50B3, and 50B4, and executes vision detection on the read image.

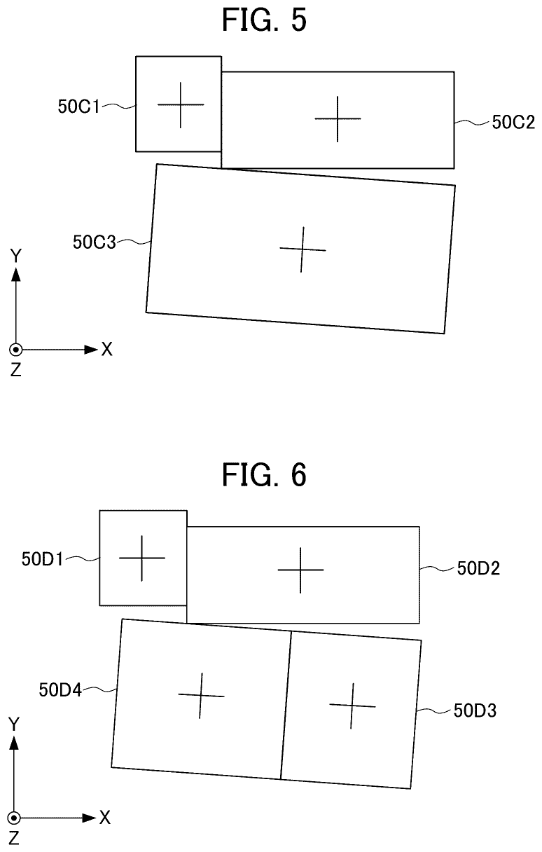

FIG. 5 is a diagram illustrating an example of the image captured after changing the positions of the cardboard boxes 50 illustrated in FIG. 4.

Through vision detection on the image in FIG. 5, the detection unit 120 detects the three cardboard boxes 50C1, 50C2, and 50C3 (represented as thick-lined rectangles) and acquires the positions (positions marked with a plus sign) X_{C1}, X_{C2}, X_{C3}, posture P_{C1}, P_{C2}, P_{C3}, and external shape information (width W_{C1}, W_{C2}, W_{C3} and depth D_{C1}, D_{C2}, D_{C3}) of the detected cardboard boxes 50C1, 50C2, and 50C3. Although the detection unit 120 detected the two cardboard boxes 50B3 and 50B4 in FIG. 4 (cardboard boxes 50A2 and 50A3 in FIG. 3) as two separate cardboard boxes, the auxiliary operation by the robot 30 has disabled the detection unit 120 from detecting the gap between the cardboard boxes 50B3 and 50B4, and consequently, the cardboard boxes 50B3 and 50B4 are erroneously detected as a single cardboard box 50C3. Thus, executing the auxiliary operation may sometimes bring about a counterproductive effect, causing erroneous detection of what was correctly detected originally.

The detection unit 120 integrates and calculates the first type of image data, the second type of image data, and the third type of image data, each containing the vision detection results before and after executing the plurality of auxiliary operations illustrated in FIGS. 3 to 5. For example, by calculating an area from the width and depth of the detected contour of the cardboard box 50, and then calculating and comparing the difference in area between the vision detection results in FIGS. 3 and 4, the detection unit 120 can determine that the two cardboard boxes 50B1 and 50B2 were erroneously detected as a single cardboard box 50A1. This allows the detection unit 120 to output the correct final detection result, including the positions, posture, and external shape information on each of the cardboard boxes 50D1 to 50D4, as illustrated in FIG. 6, and store the final detection result as a file in the storage unit 200. The detection unit 120 outputs the detection results to the robot control device 20.

The above has described outputting the final result of detecting a plurality of workpieces in the case of detecting the position, posture, and external shape information on the workpieces, based on the amount of change in such attributes. However, this is not limiting. For example, by calculating the amount of change (difference) between only the two images illustrated in FIGS. 3 and 4 captured before and after executing the first operation, a significant difference in pixel values can be observed within the same region, as a result of moving the cardboard boxes, between the region of the cardboard box 50A1 on the image before the operation and the region of the cardboard boxes 50B1 and 50B2 on the image after the operation. If the cardboard box 50A1 is a single cardboard box instead of two cardboard boxes stuck together, there should be little difference in image within the region of the cardboard 50A1 before and after executing the auxiliary operation. A large difference indicates that the auxiliary operation has separated the two cardboard boxes that were stuck together. This confirms that the two cardboard boxes stuck together were erroneously detected as a single cardboard box.

### Detection Processing of Vision System 1

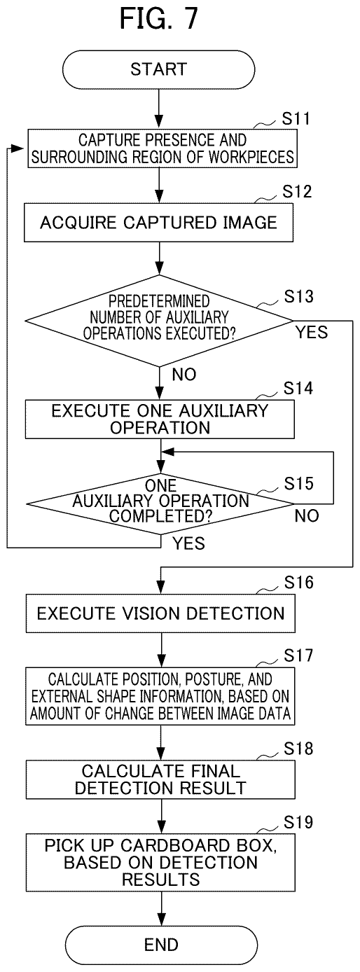

Next, the flow of the detection processing of the vision system 1 will be described with reference to FIG. 7.

FIG. 7 is a flowchart illustrating the detection processing of the vision system 1. The flow described here is repeatedly executed each time the imaging device 40 captures images of the plurality of cardboard boxes 50.

In Step S11, the imaging device 40 captures the presence and surrounding region of the plurality of cardboard boxes 50.

In Step S12, the vision detection device 10 (acquisition unit 110) acquires the image captured in Step S11, and stores the acquired image in the storage unit 200.

In Step S13, the robot control device 20 determines whether the robot 30 has executed a predetermined number of auxiliary operations (e.g., two times) on the plurality of cardboard boxes 50 using the hand 31. If the robot 30 has executed the predetermined number of auxiliary operations using the hand 31, the processing proceeds to Step S16. If the robot 30 has not executed the predetermined number of auxiliary operations using the hand 31, the processing proceeds to Step S14.

In Step S14, the robot control device 20 causes the robot 30 to execute one auxiliary operation in the predetermined direction as illustrated in FIGS. 3 and 4.

In Step S15, the robot control device 20 determines whether the one auxiliary operation in Step S14 is completed. If the one auxiliary operation is completed, the processing returns to Step S11. If the one auxiliary operation is not completed, the processing waits until the one auxiliary operation is completed.

In Step S16, the vision detection device 10 (detection unit 120) reads the image captured in Step S11 from the storage unit 200, and executes vision detection on the read image.

In Step S17, the vision detection device 10 (detection unit 120) calculates the differences in position, posture, or external shape information between the image data containing the vision detection results, and calculates the position, posture, and external shape information on each cardboard box 50, based on the calculated differences (amount of change).

In Step S18, the vision detection device 10 (detection unit 120) calculates the final detection result, based on the calculation results of Step S17, and outputs the final detection result to the robot control device 20.

In Step S19, the robot control device 20 controls the robot 30 to pick up one cardboard box 50, based on the detection results of Step S18.

As described above, in the vision system 1 according to the first embodiment, by causing the robot 30 to execute auxiliary operations on the plurality of cardboard boxes 50 densely stacked, the vision system 1 can execute accurate vision detection of the positions, posture, and external shape information on the individual cardboard boxes 50 from the images, even if the plurality of cardboard boxes 50 are densely stacked. As a result, the vision system 1 can accurately determine the pick-up position for the robot to pick up the workpiece, based on the detection results from the vision detection of the images.

The vision system 1 captures and integrates a plurality of images taken before and after the robot 30 executes auxiliary operations to contact the workpieces (cardboard boxes 50), thereby allowing for calculating the differences in detection position and external shape size of the workpieces on the images before and after the auxiliary operations, and determining the correct position and external shape size of the workpieces, even if the auxiliary operations result in an adverse condition where two workpieces are stuck together.

The first embodiment has been described above.

### Second Embodiment

Next, the second embodiment will be described. As described above, in the first embodiment, in a state where the plurality of workpieces are densely stacked, the robot executes the first operation to change the positions of the plurality of workpieces. After executing the first operation, the second type of image capturing the presence and surrounding region of the plurality of workpieces is acquired. Vision detection is executed on the first type of image and the second type of image, and the results of detecting the plurality of workpieces are output based on the amount of change between the first type of image data containing the detection results and the second type of image data containing the detection results. In contrast, in the second embodiment, in a case where there are regions in the first type of image where the vision detection fails to acquire three-dimensional positions (for example, when halation occurs or when the workpiece is transparent), the robot executes the first operation to touch the workpiece in the failed regions, and the contact information indicating the three-dimensional positions of the failed regions is acquired. The detection results are corrected by supplementing the three-dimensional positions of the failed regions, based on the acquired contact information. This is a point of difference from the first embodiment.

As a result, the vision system 1 can accurately determine the pick-up position for the robot to pick up the workpiece, based on the detection results from the vision detection of the images.

The second embodiment will be described below.

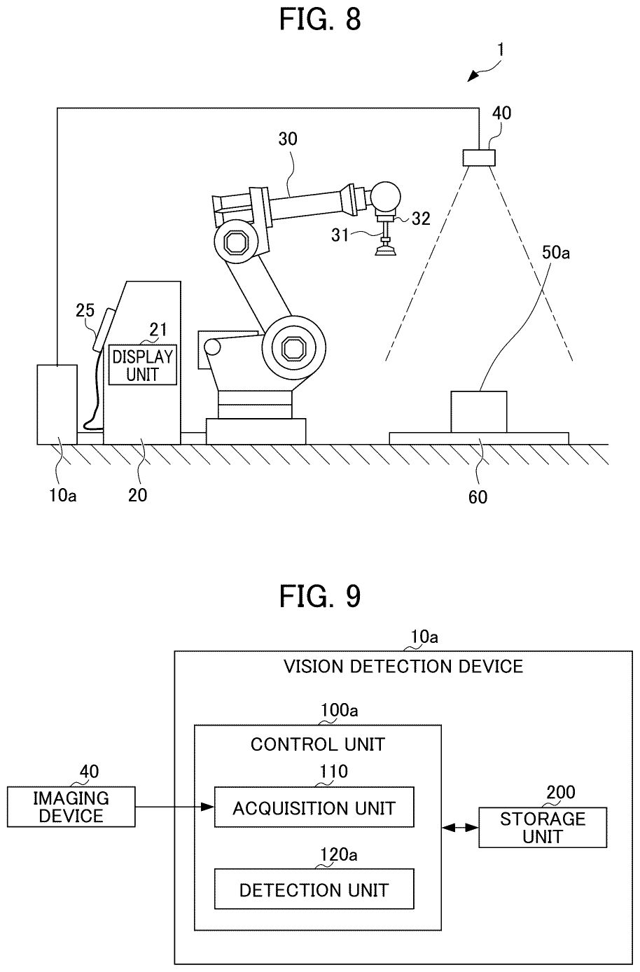

FIG. 8 is a diagram illustrating an example of the configuration of the vision system according to the second embodiment. Elements with the same functions as those in the vision system 1 in FIG. 1 are denoted by the same reference numerals, and detailed descriptions thereof are omitted.

Here, the workpiece is illustrated by examples of glossy workpieces such as stainless steel or transparent workpieces such as plastic. The present invention can also be applied to any workpiece where halation occurs, other than glossy or transparent workpieces.

As illustrated in FIG. 8, the vision system 1 includes a vision detection device 10a, the robot control device 20, the robot 30, the imaging device 40, a single workpiece 50a, and the pallet 60.

The robot control device 20, the robot 30, and the pallet 60 share the same functions as the robot control device 20, the robot 30, and the pallet 60 in the first embodiment.

A haptic sensor 32 serving as a force measurement unit is provided on the end-effector of the robot 30.

The workpiece 50a is a glossy or transparent workpiece arranged on the pallet 60.

### Vision Detection Device 10a

FIG. 9 is a functional block diagram illustrating an example of the functional configuration of the vision detection device 10a. Elements with the same functions as those in the vision detection device 10 in FIG. 2 are denoted by the same reference numerals, and detailed descriptions thereof are omitted.

The vision detection device 10a includes a control unit 100a and the storage unit 200, similar to the vision detection device 10 in the first embodiment. The control unit 100a includes the acquisition unit 110 and a detection unit 120a.

The storage unit 200 includes the same functions as the storage unit 200 in the first embodiment.

### Control Unit 100a

The control unit 100a includes a CPU, ROM, RAM, CMOS memory, etc., which are mutually communicable via a bus, as is well known to those skilled in the art.

The CPU is the processor that controls the vision detection device 10a as a whole. The CPU reads the system programs and application programs stored in the ROM via the bus and controls the entirety of the vision detection device 10a in accordance with the programs. This allows the control unit 100a to implement the functions of the acquisition unit 110 and the detection unit 120a, as illustrated in FIG. 9.

The acquisition unit 110 shares the same functions as the acquisition unit 110 in the first embodiment.

### Detection Unit 120a

The detection unit 120a, for example, similar to the detection unit 120 in the first embodiment, executes vision detection on the image of the presence and surrounding region of the workpiece 50a captured by the imaging device 40, calculates the position, posture, and external shape information on the workpiece 50a, based on the amount of change between the image data containing the detection results, and outputs the detection results to the robot control device 20. However, the detection unit 120a may fail to acquire the three-dimensional data of the position, posture, and external shape information on the workpiece when the workpiece 50a causes halation due to glossiness, such as in the case of stainless steel, or when the workpiece 50a is transparent, such as in the case of plastic.

In this case, the detection unit 120a outputs a signal indicating the failure to acquire the three-dimensional data to the robot control device 20, for example. The robot control device 20 executes an auxiliary operation (first operation) to cause the hand 31 of the robot 30 to touch and contact the workpiece 50a, and the haptic sensor 32 installed on the end-effector of the robot 30 detects the contact with the workpiece 50a. The detection unit 120a calculates and supplements the shape of the workpiece 50a, based on the contact information (haptic data) measured by the haptic sensor 32 either for the entire workpiece 50a or the region where the measurement result of the three-dimensional position of the workpiece 50a is missing due to halation, and corrects the three-dimensional position of the workpiece 50a. The contact information preferably includes information on the presence or absence of contact, and information on the contact position. The detection unit 120a then outputs the corrected detection results to the robot control device 20.

The detection unit 120a may also correct the images (first type of image, second type of image) captured by the imaging device 40, based on the contact information.

### Detection Processing of Vision System 1

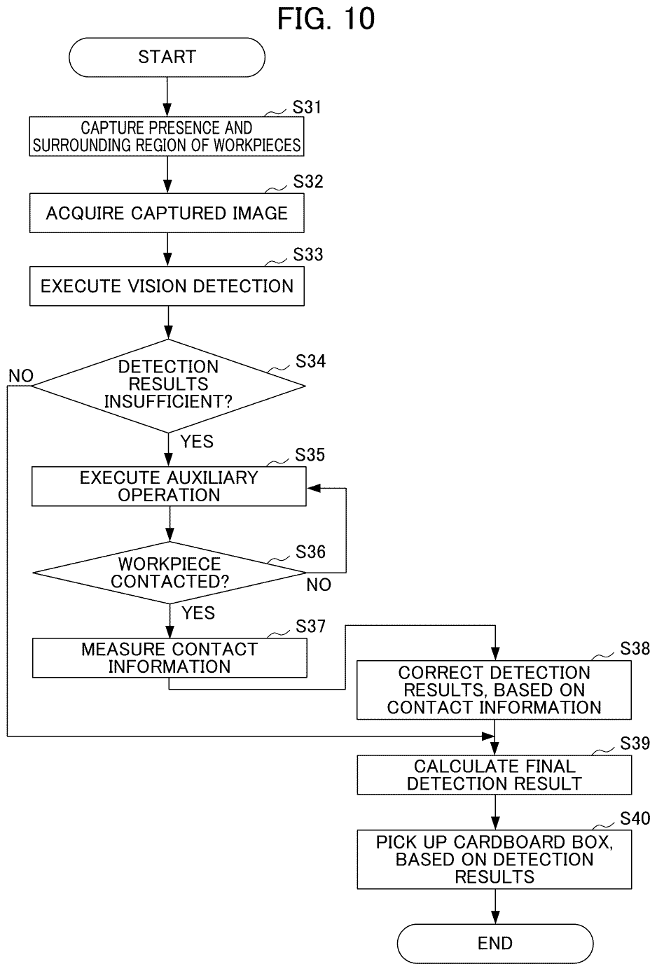

Next, the flow of the detection processing of the vision system 1 will be described with reference to FIG. 10.

FIG. 10 is a flowchart illustrating the detection processing of the vision system 1. The flow described here is repeatedly executed each time the imaging device 40 captures an image of the workpiece 50a.

The processing in Steps S31, S32, S39, and S40 is the Same as the processing in Steps S11, S12, S18, and S19 of the first embodiment, and the descriptions thereof are omitted.

In Step S33, the vision detection device 10a (detection unit 120a) executes vision detection on the image captured in Step S11.

In Step S34, the vision detection device 10a (detection unit 120a) determines whether the detection result for the image is insufficient (e.g., due to halation or the transparency of the workpiece 50a). If the detection result is insufficient (e.g., due to halation or the transparency of the workpiece 50a), the detection unit 120a outputs a signal indicating the failure to acquire the three-dimensional data to the robot control device 20, and the processing proceeds to Step S35. On the other hand, in a case where the detection result is sufficient (e.g., no halation occurs and the workpiece 50a is not transparent), the processing proceeds to Step S39.

In Step S35, the robot control device 20 executes an auxiliary operation to cause the hand 31 of the robot 30 to touch and contact the workpiece 50a.

In Step S36, the robot control device 20 determines whether the hand 31 has contacted the workpiece 50a, based on the haptic data from the haptic sensor 32. If the hand 31 has contacted the workpiece 50a, the processing proceeds to Step S37. If the hand 31 has not contacted the workpiece 50a, the processing returns to Step S35 and waits until contact is made.

In Step S37, the haptic sensor 32 measures the contact information (haptic data) of the entire workpiece 50a or the region where the measurement result of the three-dimensional position of the workpiece 50a is missing due to halation, based on the auxiliary operation in Step S35.

In Step S38, the vision detection device 10a (detection unit 120a) corrects the result of detecting the workpiece 50a, based on the contact information measured by the haptic sensor 32, either for the entire workpiece 50a or the region where the measurement result of the three-dimensional position of the workpiece 50a is missing due to halation.

Thus, in the vision system 1 according to the second embodiment, in a case where there is a region in the first type of image captured by the imaging device 40 where the vision detection fails to acquire three-dimensional position (for example, when halation occurs or when the workpiece 50a is transparent), the robot 30 executes an auxiliary operation to touch and contact the workpiece 50a with the hand 31. The haptic sensor 32 installed on the end-effector measures the entire workpiece 50a or the region where the measurement result of the three-dimensional position of the workpiece 50a failed due to halation. Based on the measured contact information, the shape of the workpiece 50a is calculated and supplemented, thereby correcting the results of detecting the workpiece 50a. As a result, the vision system 1 can accurately determine the pick-up position for the robot to pick up the workpiece, based on the detection results from the vision detection of the images.

That is, the vision system 1 extracts features by calculating the change in the force level from the contact information, including the contact force or contact moment when the robot 30 contacts the workpiece 50a, and feeds back the features reflecting the force information at the contact position where the hand 31 actually contacts the workpiece 50a into the vision detection results, whereby the vision system 1 can add information that cannot be obtained through vision alone, and correct detection results which tend to be erroneous through vision, thereby achieving highly accurate detection results.

The second embodiment has been described above.

### Modification of Second Embodiment

In the second embodiment, a single workpiece 50a is arranged on the pallet 60, but this is not limiting. For example, a plurality of workpieces 50a may be densely stacked, similar to the cardboard boxes 50 in the first embodiment. In this case, the vision system 1 may not be able to determine which workpiece is on top and which workpiece is at the bottom through vision detection alone. Therefore, the robot control device 20 may execute an auxiliary operation to cause the hand 31 of the robot 30 to touch the workpieces 50a, and the haptic sensor 32 to measure the contact information. The vision detection device 10a may determine the relative positions of the workpieces 50a, based on the measured contact information, and correct the vision detection results.

### Third Embodiment

Next, the third embodiment will be described. As described above, in the first embodiment, in a state where the plurality of workpieces are densely stacked, the robot executes the first operation to change the positions of the plurality of workpieces. After executing the first operation, the second type of image capturing the presence and surrounding region of the plurality of workpieces is acquired. Vision detection is executed on the first type of image and the second type of image, and the results of detecting the plurality of workpieces are output based on the amount of change between the first type of image data containing the detection results and the second type of image data containing the detection results. In the second embodiment, in a case where there are regions where the vision detection fails to acquire three-dimensional positions (for example, when halation occurs or when the workpiece is transparent), the robot executes the first operation to touch the workpiece in the failed regions, and the contact information indicating the three-dimensional positions of the failed regions is acquired. The detection results are corrected by supplementing the three-dimensional positions of the failed regions, based on the acquired contact information. This is a point of difference from the first embodiment. In the third embodiment, in a case where the surface of a single workpiece is not uniform and the features divide the surface, leading to erroneous detection that a plurality of workpieces exist (e.g., textures or materials are different in different regions on the surface), the robot executes the first operation to touch the workpiece surface, identifies changes in texture on the workpiece, distinguishes the regions, and corrects the detection result. This is a point of difference from the first and second embodiments.

As a result, the vision system 1 can accurately determine the pick-up position for the robot to pick up the workpiece, based on the detection results from the vision detection of the images.

The third embodiment will be described below.

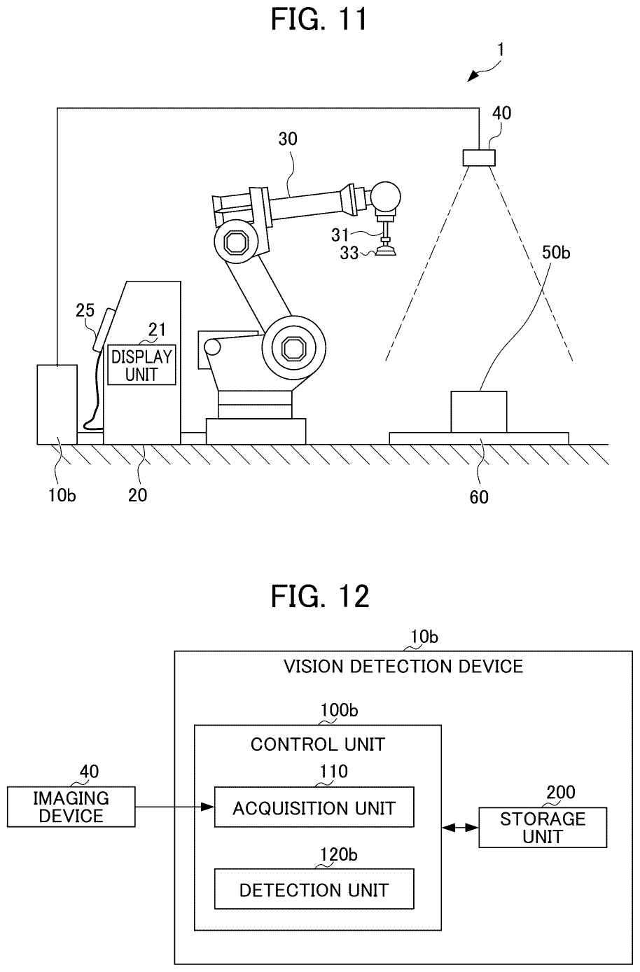

FIG. 11 illustrates an example of the configuration of the vision system according to the third embodiment. Elements with the same functions as those in the vision system 1 in FIG. 1 are denoted by the same reference numerals, and detailed descriptions thereof are omitted.

Here, the workpiece is illustrated by examples of cardboard boxes with tape and labels such as address labels attached. The present invention can also be applied to any workpiece, other than cardboard boxes attached with tape and labels.

As illustrated in FIG. 11, the vision system 1 includes a vision detection device 10b, the robot control device 20, the robot 30, the imaging device 40, a single workpiece 50b, and the pallet 60.

The robot control device 20, the robot 30, and the pallet 60 share the same functions as the robot control device 20, the robot 30, and the pallet 60 in the first embodiment.

The tactile/haptic sensor 33 serving as a force measurement unit is provided on the end-effector of the hand 31.

The workpiece 50b is a cardboard box with tape and a label such as an address label attached, and is arranged on the pallet 60. Hereinafter, unless otherwise specified, the workpiece will also be referred to as the cardboard box 50b.

### Vision Detection Device 10b

FIG. 12 is a functional block diagram illustrating an example of the functional configuration of the vision detection device 10b. Elements with the same functions as those in the vision detection device 10 in FIG. 2 are denoted by the same reference numerals, and detailed descriptions thereof are omitted.

The vision detection device 10b includes a control unit 100b and the storage unit 200, similar to the vision detection device 10 in the first embodiment. The control unit 100b includes the acquisition unit 110 and a detection unit 120b.

The storage unit 200 shares the same functions as the storage unit 200 in the first embodiment.

### Control Unit 100b

The control unit 100b includes a CPU, ROM, RAM, CMOS memory, etc., which are mutually communicable via a bus, as is well known to those skilled in the art.

The CPU is the processor that controls the vision detection device 10b as a whole. The CPU reads the system programs and application programs stored in the ROM via the bus and controls the entire vision detection device 10b in accordance with the programs. This allows the control unit 100b to implement the functions of the acquisition unit 110 and the detection unit 120b, as illustrated in FIG. 12.

The acquisition unit 110 shares the same functions as the acquisition unit 110 in the first embodiment.

### Detection Unit 120b

The detection unit 120b, similar to the detection unit 120 in the first embodiment, for example, executes vision detection on the image of the presence and surrounding region of a single cardboard box 50b captured by the imaging device 40, calculates the position, posture, and external shape information on the cardboard box 50b, based on the amount of change between the image data containing the detection results, and outputs the detection results to the robot control device 20. However, since tape and a label such as an address label are attached to the cardboard box 50b, the detection unit 120b may erroneously detect the cardboard box 50b as three different workpieces with different textures, including the tape portion (hereinafter referred to as the ‘tape region’), the label portion (hereinafter referred to as the ‘label region’), and the cardboard region (hereinafter referred to as the ‘plain region’).

In this case, the detection unit 120b outputs a signal to the robot control device 20, requesting confirmation whether the three different textures belong to a single identical workpiece. The robot control device 20 causes the hand 31 of the robot 30 to touch and contact the cardboard box 50b, and execute an auxiliary operation (first operation) to move the hand 31 along the surface of the cardboard box 50b while maintaining contact with the cardboard box 50b with a constant force (e.g., 5N). At this time, the tactile/haptic sensor 33 installed on the end-effector of the hand 31 measures the waveform of the contact force generated by the contact with the surface of the cardboard box 50b.

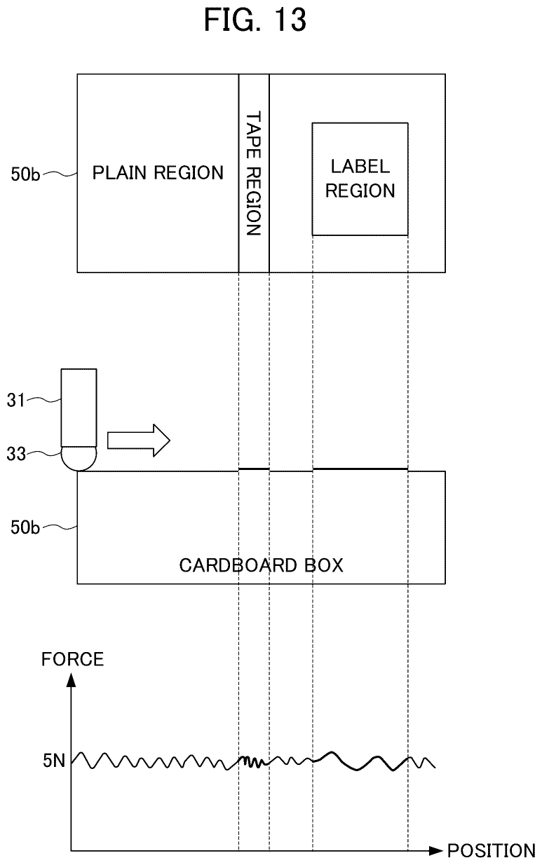

FIG. 13 is a diagram illustrating an example of the waveform of the contact force generated by the contact with the surface of the cardboard box 50b, as measured by the tactile/haptic sensor 33. The upper part of FIG. 13 illustrates an example of the tape region, the label region, and the plain region on the surface of the cardboard box 50b. The middle part of FIG. 13 illustrates an example of the auxiliary operation. The lower part of FIG. 13 illustrates a graph of the waveform of the contact force measured by the tactile/haptic sensor 33.

As illustrated in FIG. 13, even when pressed with the same predetermined force, the pattern of changes in the force (such as amplitude and frequency) differs due to the differences in the material textures of the tape region, the label region, and the plain region. The detection unit 120b calculates the amplitude and frequency of the waveform from the measured waveform of the contact force (contact information) to identify the tape region, the label region, and the plain region. The detection unit 120b corrects the detection results by eliminating the adverse effects of the tape and label, thereby obtaining correct vision detection results for the single cardboard box 50b with tape and a label attached. The detection unit 120b outputs the corrected detection results to the robot control device 20.

The contact information may include the waveform of the force as information on the amount of change in magnitude, direction, and distribution of the contact force, as well as information on the presence or absence of contact, information on the contact position, information on the magnitude and direction of the contact moment, and information on slippage.

### Detection Processing of Vision System 1

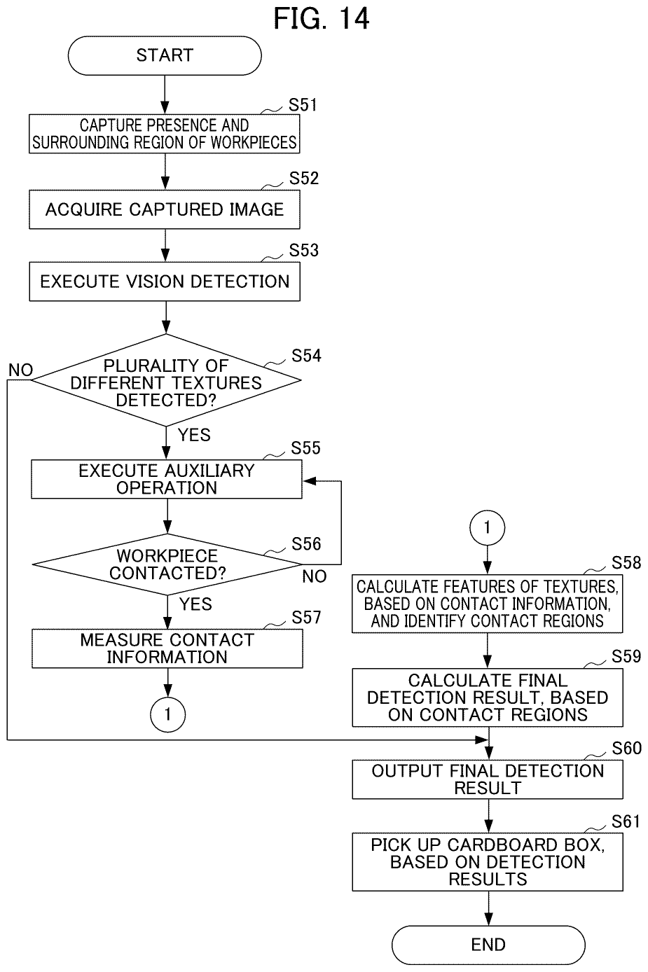

Next, the flow of the detection processing of the vision system 1 will be described with reference to FIG. 14.

FIG. 14 is a flowchart illustrating the detection processing of the vision system 1. The flow described here is repeatedly executed each time the imaging device 40 captures an image of the cardboard box 50b.

The processing in Steps S51 through S53, Steps S55 through S57, and Step S61 is the same as the processing in Steps S31 through S33, Steps S35 through S37, and Step S40 of the second embodiment, and the descriptions thereof are omitted.

In Step S54, the vision detection device 10b (detection unit 120b) determines whether a plurality of different textures have been detected during the vision detection in Step S53. If a plurality of different textures have been detected, the vision detection device 10b (detection unit 120b) outputs a signal to the robot control device 20, requesting confirmation whether the plurality of different textures belong to a single identical workpiece, and the processing proceeds to Step S55. On the other hand, if a plurality of different textures have not been detected, the processing proceeds to Step S60.

In Step S58, the vision detection device 10b (detection unit 120b) calculates the features of the textures of the surface of the cardboard box 50b, based on the waveform of the force (contact information) measured by the tactile/haptic sensor 33 when the hand 31 of the robot 30 contacts the top surface of the cardboard box 50b with a constant force, and identifies the contact regions as the tape region, the label region, and the plain region.

In Step S59, the vision detection device 10b (detection unit 120b) calculates the final detection result, recognizing the cardboard box 50b as a single workpiece, based on the contact regions identified in Step S58.

In Step S60, the vision detection device 10b (detection unit 120b) outputs the final detection result to the robot control device 20.

As a result, in the vision system 1 according to the third embodiment, in the case of the cardboard box 50b with tape and labels such as address labels attached, the robot 30 executes an auxiliary operation to touch and contact the cardboard box 50b with the hand 31 with a constant force. The tactile/haptic sensor 33 installed on the end-effector of the hand 31 measures the waveform of the force on the top surface of the cardboard box 50b. Based on the measured contact information on the waveform of the force, the features of the textures of the cardboard box 50b are calculated, the contact regions are identified as the tape region, the label region, and the plain region, and the detection results are corrected to recognize the cardboard box 50b as a single workpiece. As a result, the vision system 1 can accurately determine the pick-up position for the robot to pick up the workpiece, based on the detection results from the vision detection of the images. That is, the vision system 1 executes an auxiliary operation to cause the robot 30 to contact the cardboard box 50b, calculates the patterns of change in the force, based on the measurement information from the tactile/haptic sensor 33 in the contact region when the robot 30 contacts the cardboard box 50b, and extracts the features of the textures. Based on the extracted features, the contact regions are divided into the tape region, the label region, and the plain region. This allows the vision system 1 to obtain correct vision detection results, eliminating the adverse effects of the tape and labels.

The third embodiment has been described above.

### Modification of Third Embodiment

In the third embodiment, the workpiece is the cardboard box 50b with tape and a label such as an address label attached, but this is not limiting. For example, grooves or the like may be formed on the top surface of the workpiece. In this case as well, the detection unit 120b may instruct the robot control device 20 to cause the hand 31 of the robot 30 to touch and contact the top surface of the workpiece where grooves or the like are formed, and execute an auxiliary operation (first operation) to move the hand 31 along the top surface of the workpiece while maintaining the contact with a constant force (e.g., 5N). At this time, the tactile/haptic sensor 33 installed on the end-effector of the hand 31 measures the waveform of the force generated by the contact with the top surface of the workpiece.

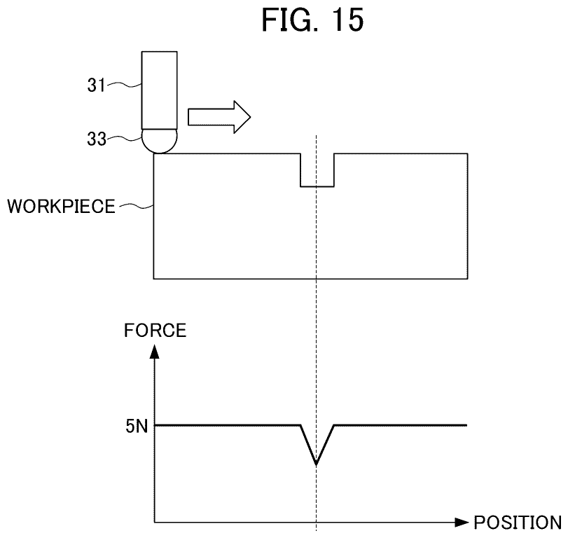

FIG. 15 is a diagram illustrating an example of the waveform of the force generated by the contact with the top surface of the workpiece, as measured by the tactile/haptic sensor 33. The upper part of FIG. 15 illustrates an example of the auxiliary operation. The lower part of FIG. 15 illustrates an example of the waveform of the force measured by the tactile/haptic sensor 33.

As illustrated in FIG. 15, when the hand 31 of the robot 30 moves into the groove of the workpiece, the magnitude of the force measured by the tactile/haptic sensor 33 decreases, and the magnitude of the force returns to the original level after passing through the groove. The detection unit 120b can determine that there is a groove at a specific location on the surface of the workpiece by identifying the points of change in the force, based on the contact information from the waveform of the force in FIG. 15.

That is, the vision system 1 can calculate a plurality of points of change in the force from the contact information, extract features such as grooves, edges, steps, holes, and protrusions, detect gaps between the workpieces, and calculate detection positions that do not include features potentially causing air leakage, thereby obtaining correct detection results.

The first, second, and third embodiments have been described above, but the vision system 1 is not limited to the described embodiments and includes modifications and improvements within the scope of the objectives.

### Modifications

In the first, second, and third embodiments, the vision detection device 10 is a device separate from the robot control device 20, but this is not limiting. For example, the vision detection device 10 may be mounted inside the robot control device 20 and integrated into the robot control device 20.

Each function included in the vision system 1 in the first, second, and third embodiments can be implemented by hardware, software, or a combination of both. Here, implementation by software means implementation by a computer reading and executing a program.

The program can be stored and supplied to a computer using various types of non-transitory computer-readable media. Non-transitory computer-readable media include various types of tangible storage media. Examples of non-transitory computer-readable media include magnetic recording media (e.g., flexible disks, magnetic tapes, hard disk drives), magneto-optical recording media (e.g., magneto-optical disks), CD-ROM (Read Only Memory), CD-R, CD-R/W, and semiconductor memories (e.g., mask ROM, PROM (Programmable ROM), EPROM (Erasable PROM), flash ROM, RAM). The program may also be supplied to a computer via various types of transitory computer-readable media. Examples of transitory computer-readable media include electric signals, optical signals, and electromagnetic waves. Transitory computer-readable media can supply the program to the computer via wired communication paths such as electrical wires and optical fibers, or via wireless communication paths.

The steps describing the program recorded on the recording medium include processing that is executed in chronological order along the sequence, as well as processing that is not necessarily executed in chronological order but are executed in parallel or individually.

In other words, the vision system and the vision detection method of the present disclosure can take various embodiments with the following configurations.
(1) The vision system 1 of the present disclosure includes: the acquisition unit 110 configured to acquire the first type of image in which the presence and surrounding region of the plurality of workpieces 50 is captured; the detection unit 120 configured to output the results of detecting the plurality of workpieces 50; and the robot 30 configured to execute an operation to change the position of at least one of the plurality of workpieces 50. The robot 30 executes the first operation to change the positions of the plurality of workpieces 50. The acquisition unit 110 acquires the second type of image in which the presence and surrounding region of the plurality of workpieces 50 is captured after the first operation is executed. The detection unit 120 executes detection on the first type of image and the second type of image, and outputs at least one information of the position, posture, or external shape information of the plurality of workpieces 50 as detection results, based on at least the information of the amount of change calculated between the first type of image data which containing the detection results and the second type of image data which containing the detection results.

The vision system 1 can accurately determine the pick-up position for the robot to pick up the workpiece, based on the detection results from the vision detection of the images.
(2) In the vision system 1 as described in (1), the detection unit 120 may output the detection results of the plurality of workpieces 50, based on at least one difference calculated by using at least one information of the position, posture, or external shape information of the plurality of workpieces 50 included in the first type of image data and the second type of image data.
(3) In the vision system 1 as described in (1) or (2), the robot 30 may execute the second operation different from the first operation by changing the positions of the plurality of workpieces 50, the acquisition unit 110 may acquire the third type of image in which the plurality of workpieces 50 is captured after executing the second operation, and the detection unit 120 may execute detection on the third type of image and output the detection results, based on at least the information of the amount of change calculated between at least any two of the first type of image data, the second type of image data, and the third type of image data which including the detection results.
(4) In the vision system 1 as described in any one of (1) to (3), the robot 30 may include the haptic sensor 32 (tactile/haptic sensor 33) configured to measure contact information when contacting the plurality of workpieces 50, the robot 30 may execute an operation to contact the surface of the plurality of workpieces 50, based on at least one detection result of the first type of image and/or the second type of image, and the haptic sensor 32 (tactile/haptic sensor 33) may measure the contact information on the surface.
(5) In the vision system 1 as described in (4), the robot 30 may execute at least the first operation on the plurality of workpieces 50a, based on the contact information.
(6) In the vision system 1 as described in (4) or (5), the contact information may include at least one of information on the presence or absence of contact, information on the contact position, information on the magnitude, direction, and distribution of the contact force, information on the magnitude and direction of the contact moment, or information on slipping.
(7) In the vision system 1 as described in any one of (4) to (6), the detection unit 120a, 120b may compensate the detection results, based on at least the information on the contact position among the contact information.
(8) In the vision system 1 as described in (6), the detection unit 120a may compensate at least one of the first type of image, the second type of image, or the detection results, based on the information on the amount of change calculated with the magnitude, direction or distribution of the contact force.
(9) The vision system 1 as described in any one of (1) to (8) may further include the display unit 21 configured to display the detection results.
(10) In the vision system 1 as described in (9), the display unit 21 may display the first type of image or the second type of image acquired by the acquisition unit 110, together with the detection results.
(11) The display unit may be, for example, a display operable by a user via a touch panel. The display unit may display a user interface, and the user may specify the position for the robot to execute the first operation or the second operation, the magnitude and direction of the force to be applied, the number of times, and the conditions, based on the first type of image or the second type of image displayed on the user interface. Via the user interface, the user may specify the position for the robot to execute the contact operation, the magnitude and direction of the contact force, the path for moving while in contact, or the region to be contacted.

The user interface may include a setting screen that allows for setting the parameters related to the operating conditions of the robot or the imaging conditions of the imaging device. The user interface may display the first type of image and the second type of image (and the third type of image) superimposed or side by side. The user interface may display the detection results together with the first type of image, etc. The user interface may display the detection information detected by the force measurement unit while the robot is executing the contact operation.
(12) The vision detection method of the present disclosure includes: the acquiring step of acquiring the first type of image in which the presence and surrounding region of the plurality of workpieces 50 is captured; the detecting step of outputting the results of detecting the plurality of workpieces 50; and the executing step of causing the robot 30 to execute an operation to change the position of at least one of the plurality of workpieces 50. In the executing step, the first operation for the robot 30 to change the positions of the plurality of workpieces 50 is executed. In the acquiring step, the second type of image is acquired, in which the presence and surrounding region of the plurality of workpieces 50 after executing the first operation is captured. In the detecting step, detection on the first type of image and the second type of image is executed, and at least one information of the position, posture, or external shape information of the plurality of workpieces 50 is output as the detection result, based on at least the information of the amount of change calculated between the first type of image data which including the detection results and the second type of image data which including the detection results.

According to this vision detection method, the same effects as described in (1) can be achieved.

### EXPLANATION OF REFERENCE NUMERALS

1: vision system
10, 10a, 10b: vision detection device
100, 100a, 100b: control unit
110: acquisition unit
120, 120a, 120b: detection unit
200: storage unit
20: robot control device
21: display unit
25: teaching console
30: robot
31: retrieving hand
32: haptic sensor
33: tactile/haptic sensor
40: imaging device
50: cardboard box
60: pallet

1. A vision system, comprising:
an acquisition unit configured to acquire a first type of image in which a presence and surrounding region of a plurality of workpieces is captured;
a detection unit configured to output a result of detecting the plurality of workpieces; and
a robot configured to execute an operation to change at least one of positions of the plurality of workpieces, wherein
the robot executes a first operation to change the positions of the plurality of workpieces, the acquisition unit acquires a second type of image in which the presence and surrounding region of the plurality of workpieces is captured after executing the first operation, and
the detection unit executes detection on the first type of image and the second type of image, and outputs at least one information of a position, posture, or external shape information of the plurality of workpieces as the detection result, based on at least the information of an amount of change calculated between first type of image data which containing a detection result and second type of image data which containing a detection result.

2. The vision system according to claim 1, wherein the detection unit outputs the detection result of the plurality of workpieces, based on a difference calculated by using at least one information of the position, posture, or external shape information of the plurality of workpieces included in the first type of image data and the second type of image data.

3. The vision system according to claim 1, wherein
the robot executes a second operation, different from the first operation, to change the positions of the plurality of workpieces,
the acquisition unit acquires a third type of image in which the plurality of workpieces is captured after executing the second operation, and
the detection unit executes detection on the third type of image and outputs the detection result, based on at least the information of an amount of change calculated between any two of the first type of image data, the second type of image data, and the third type of image data which containing a detection result.

4. The vision system according to claim 1, wherein
the robot includes a force measurement unit configured to measure contact information when contacting the plurality of workpieces,
the robot executes an operation to contact a surface of the plurality of workpieces, based on at least one result of the detection on the first type of image and/or the second type of image, and
the force measurement unit measures the contact information on the surface.

5. The vision system according to claim 4, wherein the robot executes at least the first operation on the plurality of workpieces, based on the contact information.

6. The vision system according to claim 4, wherein the contact information includes at least one of information on presence or absence of contact, information on a contact position, information on magnitude, direction, and distribution of a contact force, information on magnitude and direction of a contact moment, or information on slippage.

7. The vision system according to claim 4, wherein the detection unit compensates the detection result, based on at least the information on a contact position among the contact information.

8. The vision system according to claim 6, wherein the detection unit compensates at least one of the first type of image, the second type of image, or the detection result, based on the information on an amount of change calculated with magnitude, direction or distribution of the contact force.

9. The vision system according to claim 1, further comprises a display unit configured to display the detection result.

10. The vision system according to claim 9, wherein the display unit displays the first type of image or the second type of image acquired by the acquisition unit, together with the detection result.

11. A vision detection method, comprising:
an acquiring step of acquiring a first type of image in which a presence and surrounding region of a plurality of workpieces is captured;
a detecting step of outputting a result of detecting the plurality of workpieces; and
an executing step of causing a robot to execute an operation to change at least one of positions of the plurality of workpieces, wherein
in the executing step, the robot executes a first operation to change the positions of the plurality of workpieces,
in the acquiring step, a second type of image is acquired, in which a presence and surrounding region of the plurality of workpieces after executing the first operation is captured, and
in the detecting step, detection on the first type of image and the second type of image is executed, and at least one information of a position, posture, or external shape information of the plurality of workpieces is output as the detection result, based on at least the information of an amount of change calculated between the first type of image data which containing the detection result and the second type of image data which containing the detection result.
